(19) United States
(12) Patent Application Publication
(10) Pub. No.: US 2007/0213029 A1
(43) Pub. Date: Sep. 13, 2007

(54) System and Method for Provisioning of Emergency Calls in a Shared Resource Network

(75) Inventors: Jonathan P. Edney, Cambridgeshire (GB); Stefano Faccin, Dallas, TX (US)

Correspondence Address: HAYNES AND BOONE, LLP, 901 MAIN STREET, SUITE 3100, DALLAS, TX, 75202, US

(73) Assignee: Nokia Corporation, Espoo (FI)

(21) Appl. No.: 11/621,875

(22) Filed: Jan. 10, 2007

Related U.S. Application Data
(60) Provisional application No. 60/758,846, filed on Jan. 13, 2006.

(51) Int. Cl. H04M 11/04

(52) U.S. Cl. 455/404.1; 455/456.2

(57) ABSTRACT

A system and method for provisioning emergency services in a wireless local area network is provided. A station may assert an emergency service in a network by generating an association request that includes an indication of a request for an emergency service. The association request is transmitted to a network access point, and the station may be associated with the access point without engaging in an authentication procedure. Additionally, a network access point is provided that facilitates provisioning of emergency services to authenticated or unauthenticated network stations. An access point receives an association request that includes an indication of a request for an emergency service, and transmits an association response to a station that originated the association request. The originator of the association request may be associated with the access point without the access point engaging in an authentication procedure with the requesting station. Additionally, the access point may segregate emergency service traffic from general-purpose traffic to prohibit exploitation of the emergency service to fraudulently access other network services.

### RELATED APPLICATION DATA

This patent application claims the benefit of provisional U.S. patent application Ser. No. 60/758,846, filed Jan. 3, 2006.

### FIELD OF THE INVENTION

The present invention relates to shared resource network technologies and, more particularly, to mechanisms for enabling provisioning of emergency calls for users. Still more particularly, the present invention provides a system and method for provisioning emergency calls to authenticated and unauthenticated users in a wireless local area network.

### BACKGROUND

Wireless local area networks (WLANs) are becoming increasingly popular for both business and residential applications. For instance, many companies are deploying WLANs in place of, or as an enhancement to, the corporate local area network. Additionally, many service industry businesses, e.g., restaurants and hotels, have deployed WLANs to provide customers with access to the Internet or other data networks.

Because a radio link is utilized for communication channels rather than utilization of a wireline connection, provisioning of emergency services in a WLAN similar to those commonly provided by fixed networks presents various technical challenges. For example, access to WLANs may involve various association and authentication procedures with access points to prohibit unauthorized user access to the WLAN. It is desirable to provide emergency services to user stations even in the event the user is not authorized to access the WLAN for general communication purposes. However, no mechanisms are currently available for enabling a WLAN station to determine if a WLAN access point is adapted to provide emergency services, such as enhanced 911 (E911) emergency services. Moreover, provisioning of unauthenticated WLAN station access to a WLAN presents security issues, such as the exploitation of the WLAN access point and the potential access to non-emergency services.

### SUMMARY

It would be advantageous to provide a system and method for provisioning of emergency services in a wireless local area network. It would be further advantageous to provide for emergency service provisioning to unauthenticated wireless local area network stations. It would still be further advantageous to provide mechanisms that allow a wireless local area network station to identify access points that are adapted to provide emergency services. It would still be further advantageous to provide emergency services to unauthenticated wireless local area network stations in a manner that avoids exploitation of the wireless local area network access point.

Embodiments of the present invention provide a system and method for asserting emergency services in a wireless local area network. A station may assert an emergency service in a network by generating an association request that includes an indication of a request for an emergency service. The association request is transmitted to a network access point, and the station may be associated with the access point without engaging in an authentication procedure Mechanisms are provided for segregating emergency service traffic from other general purpose traffic to prohibit fraudulent exploitation of network infrastructure.

### BRIEF DESCRIPTION OF THE DRAWINGS

Aspects of the present disclosure are best understood from the following detailed description when read with the accompanying figures.

FIG. 1 is a simplified block diagram of an exemplary network environment in which embodiments disclosed herein may be implemented;

FIG. 2 is a diagrammatic representation of an embodiment of a service indication information element that facilitates provisioning of emergency calls in a shared resource network;

FIG. 3 is a diagrammatic representation of an embodiment of a basic service set identifier information field that facilitates advertisement of E911 capabilities;

FIG. 4 is a diagrammatic representation of an embodiment of an association request frame that may be generated by a station for asserting an emergency service in a network;

FIG. 5 is a diagrammatic representation of an embodiment of a virtual local area network table depicted in FIG. 1 that is maintained, or otherwise accessible, by a emergency services compliant access point that facilitates segregation of emergency service traffic from non-emergency service traffic;

FIG. 6 is a flowchart of an embodiment of an access point processing routine that facilitates provisioning of emergency services; and

FIG. 7 is a flowchart of an embodiment of an access point processing subroutine for processing a request for emergency services from a currently associated station.

### DETAILED DESCRIPTION

It is to be understood that tie following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

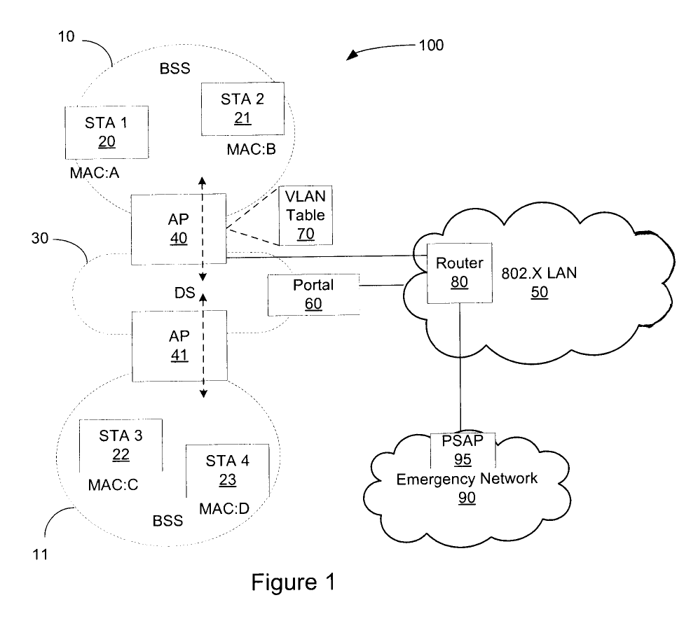

FIG. 1 is a simplified block diagram of an exemplary network 100 environment in which embodiments disclosed herein may be implemented. Network 100 is an example of a shared resource network. For example, network 100 may be implemented as a wireless local area network (WLAN) conforming to the Institute of Electrical and Electronics (IEEE) 802.11 standards.

In the illustrative example, network 100 comprises two basic service sets (BSSs) 10-11 although any number of BSSs may be included in network 100. BSSs 10-11 provide respective coverage areas (illustratively designated with dashed lines) in which WLAN stations (STAs) 20-23 may communicate via a wireless medium with one another or with other communication or computational devices in other external networks that interface with network 100. STAs 20-23 each have an associated address, such as one of respective Media Access Control (MAC) addresses MAC:A-MAC:D. A Media Access Control address is uniquely associated with the device hardware, e.g., a network interface card such as secure digital input/output card, a compact flash card, a miniPCI port card, or a PCMCIA card. The MAC address uniquely identifies the device within network 100. MAC addresses are typically implemented as a predefined length binary number, such as a 48-bit value. In the illustrative example, MAC addresses designated as alphabetic values are provided for illustrative purposes and are representative of binary physical addresses. Additionally, each of STAs 20-23 may have a logical, e.g., Internet protocol (IP) address, associated therewith. BSSs 10-11 are communicatively interconnected by a distribution system (DS) 30. DS 30 enables mobile device support by providing requisite logical services for handling address to destination mapping and integration of multiple BSSs. Each BSS includes an access point (AP) that provides access to DS 30. In the illustrative example, each of BSSs 10-11 have a respective AP 40-41. DS 30 provided by APs 40-41 and BSSs 10-11 facilitate creation of a wireless network of arbitrary size and complexity, and the collection of DS 30 and BSSs 10-11 is commonly referred to as an extended service set network. Logical integration between network 100 and non-IEEE 802.11 LANs, e.g., LAN 50, may be provided by a portal 60. Various other configurations of network 100 are possible. For example, coverage areas provided by BSSs 10 and 11 may partially overlap or may be collocated. Moreover, embodiments of the invention may be deployed in a WLAN comprising a single independent BSS. Additionally, wireless virtual local area networks (VLANs) may be configured in network 100. To this end, one or more APs, such as AP 40, may include or interface with a VLAN table 70. A VLAN may be configured to facilitate segregation of emergency traffic from general purpose traffic (i.e., non-emergency traffic) as described more fully hereinbelow.

Provisioning of emergency services may be provided by an emergency network 90 that is interconnected with LAN 50. Emergency network 90 may include a public safety answering point (PSAP) 95 at which emergency personnel may be connected with an emergency call. In the illustrative example, AP 40 interconnects with emergency network 90 by way of LAN 50. For example, AP 40 may interconnect with a router 80 that is communicatively coupled with PSAP 95. Various PSAPs may be disposed in emergency network 90, and any number of network components may be used to connect AP 40 with an appropriate PSAP. Depiction of a coupling between AP 40 and PSAP 95 by way of router 80 is for illustrative purposes only.

Each of STAs 20-23 may be implemented as a respective data processing system adapted for communication in a wireless network, such as a wireless laptop computer, a personal digital assistant, a cellular telephone, or other device capable of wireless data communications. A STA may comprise a processing unit, such as a general purpose microprocessor and/or an application specific integrated circuit, a memory device, such as a random access memory, a read-only memory, or another storage device for holding machine-readable data, a communication interface, such as an expansion slot and wireless communication card or a wireless communication interface integrated with the STA hardware, and various other components and peripheral devices. A wireless communication interface of a STA may be, for example, implemented as a secure digital input/output (SDIO) port and accompanying SDIO WLAN card, a compact flash (CF) port and CF WLAN card, a miniPCI port and miniPCI WLAN card, a Personal Computer Memory Card International Association (PCMCIA) port and PCMCIA WLAN card, or other suitable wireless communication devices.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory in an AP or a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, or any combination thereof, executing on a single computer processor or multiple computer processors. Additionally, various steps of embodiments of the invention may provide a data structure generated, produced, received, or otherwise implemented on a computer-readable medium, such as a memory.

While the descriptions of a shared resource network, devices operating therein, and wireless medium transmissions made within the shared resource network are provided herein according to IEEE 802.11 protocols, functionality, and nomenclature, such examples are illustrative only and implementations of the invention are not limited to any particular network, network-compliant device, or network communication formats or protocols. Furthermore, descriptions of the invention provided herein in relation to implementations in an IEEE 802 conformant network are illustrative only and are provided only to facilitate an understanding of the invention. Embodiments of the present invention may be implemented on other network architectures and devices that utilize shared resources for effecting data communications.

In accordance with embodiments disclosed herein, E911 capable network components, such as AP 40 shown in FIG. 1, may advertise the E911 capabilities to STAs within network 100 by one or more of various mechanisms. For example, an AP may advertise E911 capabilities in a beacon frame, a probe response frame, a neighbor information element, or another suitable data structure. The receipt, or lack thereof, of the E911 capability advertisement by a STA allows the STA to identify whether the AP supports emergency calls. Additionally, the AP may also advertise whether quality of service (QoS) mechanisms are supported for unauthenticated E911 calls.

In accordance with an embodiment, the E911 capability may be advertised in one or more of existing information elements by an otherwise unused or free bit. In accordance with another embodiment, an E911 advertisement may be made though the introduction of a service indication information element (IE) as described below.

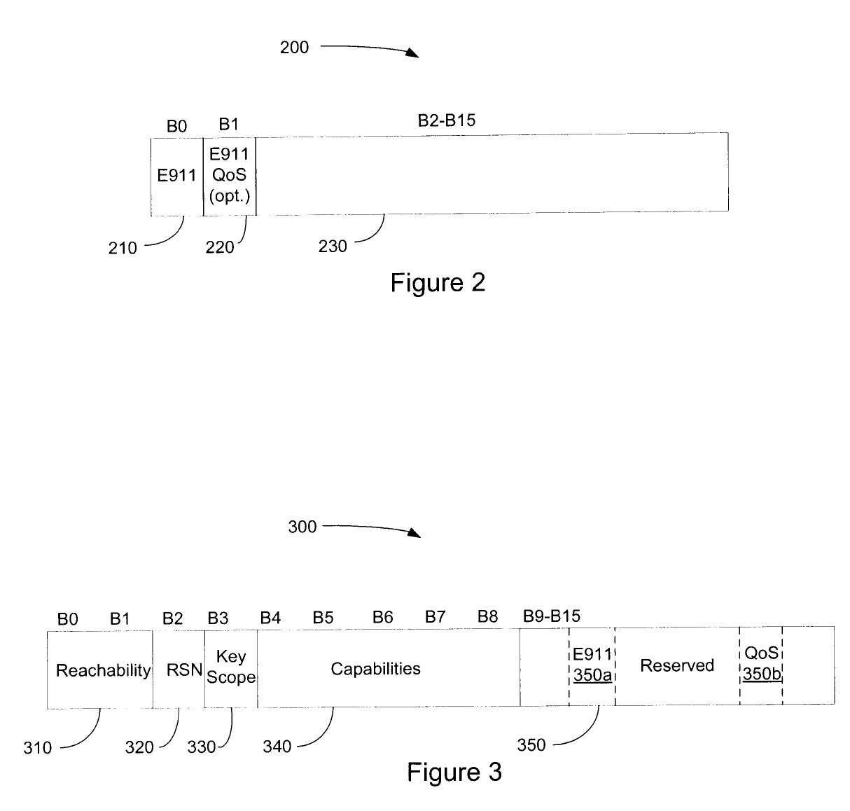

FIG. 2 is a diagrammatic representation of an embodiment of a service indication information element 200 that facilitates provisioning of emergency calls in a shared resource network. In the illustrative example, service indication information element 200 comprises a data structure of two octets including an E911 bit field 210. E911 bit field 210 may be set to a particular value, e.g., “1”, to indicate the AP transmitting IE 200 is E911-capable. Additionally, IE 200 may include an optional E911 QoS bit field 220 that may be set to a particular value, e.g. “1”, to indicate that the transmitting AP supports quality of service mechanisms for unauthenticated E911 calls. Other data may be included in field 230.

In accordance with another embodiment, a reserved bit of an information field in a BSSID may be set to advertise E911-capabilities of an AP. Additionally, another reserved bit may be set to indicated QoS support of E911 calls as described below.

FIG. 3 is a diagrammatic representation of an embodiment of a basic service set identifier (BSSID) information field 300 that facilitates advertisement of E911 capabilities. Exemplary information field 300 comprises a two octet data structure that includes a reachability bit field 310, a robust security networks (RSN) bit field 320, a key scope bit field 330, a capabilities bit field 340, and a reserved bit field 350. Reachability bit field 310 comprises a two-bit field that indicates whether the AP represented by the BSSID is reachable by a STA for pre-authentication purposes. RSN bit field 320 comprises a single bit field that indicates whether the AP represented by the BSSID matches the RSN IE capabilities of the current AP. Key scope bit field 330 comprises a single bit field that indicates whether the AP represented by the BSSID has the same authenticator identity as the AP sending the information field. Capabilities field 340 comprises a five-bit field that indicates various capability information, e.g., spectrum management, QoS, radio measurement, etc., of the AP represented by the BSSID.

In accordance with an embodiment, a bit 350a of reserved bit field 350 may be set to indicate the AP supports E911 calls. Additionally, another bit 350b of reserved bit field 350 may be set to indicate QoS support of E911 calls. Information field 300 may be included in a neighbor list entry of a neighbor list component of a neighbor report element that may be transmitted by an AP for receipt by STAs in network 100.

In another embodiment, domains, such as a security domain, a roaming domain, or the like, may be introduced in network 100. In such a network configuration, an embodiment may be implemented to provide E911 capability advertisements in an information element configured to describe the particular domain. Alternatively (or in addition thereto) reserved bit field mechanisms may be implemented in a manner similar to that described above with reference to FIG. 3 for providing E911 capability advertisements.

A STA may implement any one or more of various mechanisms for discovering E911 calls within network system 100. If a STA is unassociated or unauthenticated, the STA may attempt discovery of an E911-capable AP by passive or active scanning. In a passive scanning mode, a STA may evaluate beacon frames for an indication of E911 capabilities. In an active scanning mode, a STA may generate and transmit a probe request, and evaluate any received probe response for an indication of E911 capabilities therein. If a STA is associated or authenticated, the STA already has information regarding the E911 capabilities of the AP with which the STA is associated. In another implementation, a STA may evaluate information in a neighbor report to identify whether an AP has E911 capabilities. For example, if a STA needs to identify a target AP for roaming during an E911 call, a neighbor report may be evaluated to identify a suitable candidate for handover to maintain the call. In another scenario, a STA may be involved in a regular (non-E911 call), and may evaluate a neighbor report for E911 capabilities of candidate APs to ensure that a selected AP for handover supports E911 calls. In other implementations, APs identified in a neighbor report as supporting E911 calls may be given precedent over non-E911 call compliant APs for handover purposes.

In accordance with an embodiment, an unauthenticated STA asserts an access attempt to the emergency service by way of an indicator included in an association request frame generated and transmitted by the STA. In one implementation, the indicator may be comprise a bit set to a value, e.g., “1,” that indicates a request to access emergency service. For example, the bit may comprise a reserved bit in the capability information field of the association request frame. In another implementation, the bit may comprise a bit in an information field that is included within the association request, e.g., in a mariner similar to E911 bit field 210 shown in FIG. 2.

Additionally, other bit(s) or indicator(s) may be included in an association request. For example, additional bits or indicators may be included in the association request to specify a particular emergency service in the event that a plurality of emergency services may be supported. In this instance, multiple bits of the capabilities field may be designated for emergency service designations. An AP, in response to receipt of an association request, returns an association response that includes an indication of whether the AP supports the requested emergency service(s). Such an indication in the association response may be provided by designation of one or more bits of an association response to emergency service capability indicators, by return of an information element that provides an indication of the supported emergency service(s), or the like.

Advantageously, an AP that supports the requested emergency service may accept the association of any STA (assuming protocol compatibility) thereby providing emergency service to both authenticated and unauthenticated STAs. Moreover, the need to perform a 4-way handshake with an unauthenticated STA is averted because no keys are required to be created for authentication. Thus, no encryption keys are required to be setup between an unauthenticated STA and the AP.

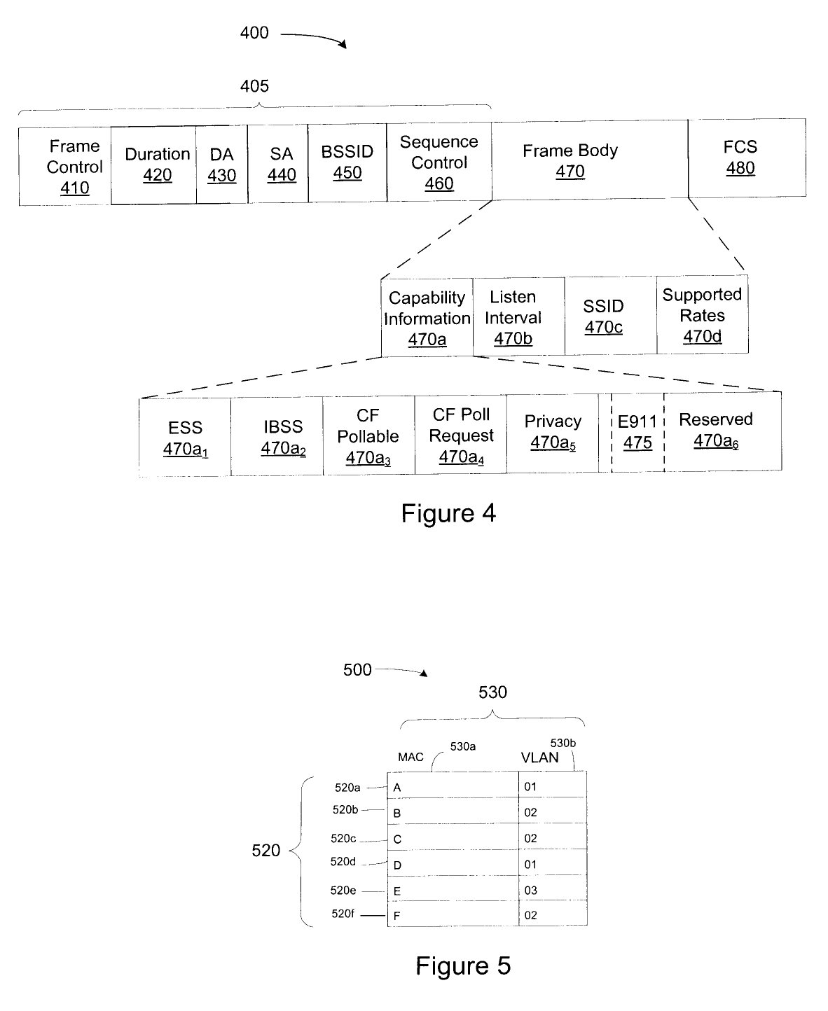

FIG. 4 is a diagrammatic representation of an association request frame 400 that may be generated by a STA for asserting an emergency service in a network. Association request frame 400 comprises a MAC header 405 that includes a frame control field 410, a duration field 420, a destination address field 430, a source address field 440, a basic service set identification field 450, and a sequence control field 460 that each may include subfields thereof and may be formatted in accordance with the IEEE 802.11 standard. Association request frame 400 may include a frame body field 470 that includes a capability information subfield 470a, a listen interval subfield 470b, a service set identifier subfield 470c, and a supported rates subfield 470d. Additionally, association request frame 400 may include a frame check sequence (FCS) field 480.

Capability information subfield 470a may include an extended service set (ESS) subfield 470a₁, an independent basic service set subfield 470a₂, a coordination function (CF) pollable subfield 470a₃, a coordination function poll request subfield 470a₄, a privacy subfield 470a₅, and a reserved subfield 470a₆. In accordance with embodiments disclosed herein, a STA desiring emergency services may assert a request therefor by including an indicator of a requested emergency service within reserved subfield 470a₆. For example, an E911 bit 475 may be included within reserved field 470a₆ that may be interpreted by a receiving AP as a request for an emergency service. The AP may then invoke an association service to associate the transmitting STA to the AP without the invocation of an authentication service. In a similar manner, a QoS bit may be included in reserved subfield 470a₆.

It is desirable to avoid exploitation of wireless local area network infrastructure, such as access points, from fraudulent unauthenticated users. To this end, embodiments disclosed herein may provide for the segregation of emergency service traffic from other non-emergency traffic.

In accordance with embodiments disclosed herein, emergency service traffic may be bridged to a common network entity dedicated to emergency services to facilitate segregation of emergency traffic from other network traffic. In one implementation a particular VLAN configured in network 100 is dedicated to emergency service traffic. For example, a pre-established tunnel may be associated with the VLAN dedicated to emergency service traffic.

FIG. 5 is a diagrammatic representation of VLAN table 70 depicted in FIG. 1 that is maintained, or otherwise accessible, by an emergency services compliant AP. Table 70 maps or otherwise logically associates identifiers of STAs to one or more particular VLANs. An identifier of a STA that is mapped to a particular VLAN may, for example, comprise a MAC address of the STA. Table 70 may be implemented as a lookup table comprising a plurality of records 520 and fields 530. Table 70 may be stored in a storage medium, such as a random access memory, dynamic random access memory, or the like, of an AP, such as AP 40 shown in FIG. 1.

Each record 520a-520f, or row, comprises associated data elements in respective fields 530a-530b. In the present example, field 530a stores physical addresses of STAs. Thus, for example, field 530a stores various MAC addresses of STAs within, or that may have been within, BSS 10. Field 530b stores VLAN identifiers to which a STA with a MAC address specified in a common record is associated. For example, field 530b of record 520a indicates a VLAN “01” to which the STA having MAC address “A” is associated. That is, STA 20 depicted in FIG. 1 is assigned to a VLAN having an identifier “01.” In a similar manner, STAs having, MAC addresses “B”-“F” are assigned to one of VLANs having a VLAN identifier of “01,” “02,” or “03.”

In accordance with an embodiment, a particular VLAN may be dedicated to servicing emergency service traffic. For example, assume the VLAN “01” is dedicated to emergency service traffic. Accordingly, STAs having MAC addresses “A” and “D” have asserted an emergency service in a respective association request transmitted to the servicing AP, and all traffic for STA having MAC addresses of “A” and “D” is segregated from other general-purpose traffic, e.g., traffic bridged to VLANs “2” and “3.” Thus, all data frames generated by a STA that has asserted an emergency service call during association are bridged to the VLAN “01” dedicated to emergency service traffic. In this manner, all emergency traffic, whether from an authenticated or unauthenticated user, is segregated from non-emergency traffic, and exploitation of other network services by an AP fraudulently asserting an emergency service to gain network access to other non-emergency services is advantageously thwarted.

If an emergency service is asserted by an authenticated and associated station, the AP may disassociate the STA and, subsequently, reassociate the station to facilitate emergency service provisioning in accordance with an embodiment. For example, assume STA 21 (having MAC address “B”) is engaged in a general purpose session within network 100 and is assigned to VLAN “02” as depicted in FIG. 5. If a user of STA 21 attempts to assert an emergency service by transmitting an association request with an asserted emergency service request indicator, AP 40 may invoke a disassociation service to terminate the current association, and complete an association service with the requesting STA. In this implementation, the assignment of STA 21 to VLAN “02” may be terminated, and STA 21 may be reassigned to VLAN “01” (that is, the VLAN dedicated to emergency service traffic). Accordingly, additional security to network 100 is provided by prohibiting a single STA from concurrent assignment to a general purpose VLAN and a VLAN allocated for emergency service traffic.

Other embodiments may, however, permit an authenticated STA to be assigned to multiple VLANs if network 100 is configured to support the concurrent assignment of multiple VLANs to a STA. In this manner, a faster connection with the emergency service network may be provided by allowing invocation of the association service in response to the service request from an authenticated station without first requiring a disassociation service to complete. For example, if authenticated STA 21 is engaged in a general purpose session and is assigned to VLAN “02” when a user attempts assertion of an emergency service, AP 40 may, upon recognition of the emergency service request, invoke an association service to assign STA 21 to VLAN “01” dedicated to emergency service traffic. In this implementation, assignment of STA 21 to VLAN “01” may be made without terminating the assignment of STA 21 to VLAN “02.” Thus, STA 21 may be assigned to one or more general purpose VLANs and a VLAN dedicated to emergency service traffic. Advantageously, AP 40 is not required to complete a disassociation service with STA 21 prior to connecting STA 21 with emergency network 90.

In accordance with another embodiment, emergency service traffic segregation may be implemented by dedicating one or more network components to servicing such traffic. For example, one or more routers or other network devices such as router 80, may be dedicated to only handling emergency service traffic. In the illustrative example of FIG. 1, AP 40 may forward all emergency service traffic to router 80 upon recognition of the traffic as related to an emergency service. For example, AP 40 may evaluate an association request for inclusion of an emergency service request indicator (such as assertion of E911 bit 475), and complete the association (assuming the STA is unassociated) with the requesting STA. Emergency related traffic from the newly associated STA is then forwarded to router 80 upon completion of the association service. Router 80, in turn, may convey the emergency service data to emergency network 90. Accordingly, traffic from a STA asserting an emergency service may be routed to a router dedicated to emergency services thereby segregating emergency service traffic from other general purpose traffic.

In the event that a STA requesting an emergency service is associated and authenticated (that is, the STA is in a local state 3), a security association is already established between the AP and requesting STA at the time the emergency service request is made. In this situation, the AP may evaluate the STA requesting the emergency service as both associated and authenticated. The AP may then tear-down or otherwise delete the existing security association of the requesting STA and notify the STA accordingly, e.g., by way of an association response or other association acknowledgement message. Responsive to termination of the association, the STA may then generate and transmit another association request with an emergency service request indicator. The AP, on receipt of the association request, may complete the association without engaging the STA in authentication procedures, and emergency service data is then forwarded to the router dedicated to emergency service traffic.

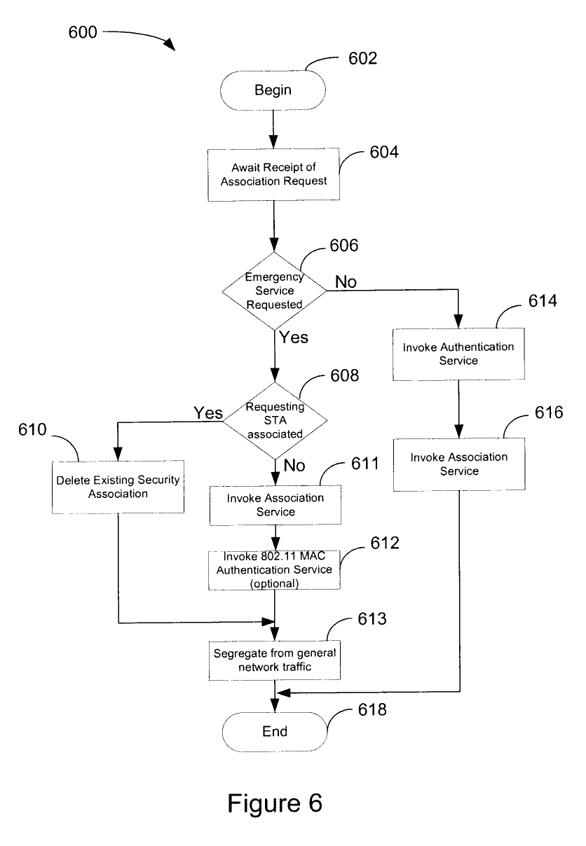

FIG. 6 is a flowchart of an embodiment of an access point processing routine that facilitates provisioning of emergency services. The AP processing routine is invoked (step 602), and the AP awaits receipt of an association request (step 604). On receipt of an association request, the AP evaluates whether an emergency service is requested (step 606). For example, the AP may evaluate a particular hit field, such as reserved subfield 470a₆ of request frame 400 depicted in FIG. 4 to determine if E911 bit 475 is asserted. If an emergency service is requested, the AP may then evaluate whether the requesting STA, that is the STA that originated the received association request, is currently associated with the AP (step 608). In the event that the STA is already associated with the AP (and is thus already authenticated), the AP may optionally delete an existing security association, e.g., a security association resulting from an 802.1x authentication service, of the STA (step 610). The AP may then proceed to segregate emergency service related traffic of the STA from other general purpose network traffic (step 613), and the AP processing routine cycle may end (step 618). In the event that the requesting station is evaluated as not currently associated with the AP at step 608, the AP processing routine may proceed to invoke an association service (step 611), and may optionally invoke an 802.11 MAC authentication service (step 612). Emergency service related traffic of the newly associated STA may be segregated from other general-purposed traffic according to step 613.

Returning again to step 606, the AP processing routine may invoke an association service (step 614) in the event that an emergency service is not requested. Upon completion of the association service, an authentication service may be invoked (step 616). For example, the authentication service may be implemented as an 802.11 MAC authentication. The AP processing routine cycle may then end according to step 618.

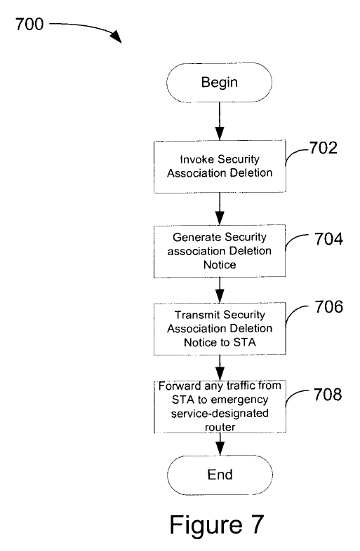

FIG. 7 is a flowchart of an embodiment of an access point processing subroutine for processing a request for emergency services from a currently associated STA. In the embodiment depicted in FIG. 7, the servicing AP and network 100 (or a portion thereof) is configured to segregate emergency service traffic from general purpose traffic by way of a router dedicated to emergency service traffic. The processing steps depicted in FIG. 7 generally correspond to steps 610 and 613 shown in FIG. 6 when the AP processing routine of FIG. 6 is implemented for segregating emergency traffic by way of a dedicated network router.

The AP invokes a security association deletion service (step 702), e.g., upon recognition that a received association request includes a request for an emergency service and is originated by a STA that is currently associated. The security association deletion service may provide the deletion of the security association of the requesting STA. A security association deletion notice or other indicator may then be generated by the AP (step 704) and transmitted to the STA (step 706). Alternatively, the security association deletion notice generated by the AP and transmitted to the STA may be implemented as an association response. The AP then forwards any traffic received from the STA to a router dedicated to emergency service traffic (step 708).

In accordance with embodiments disclosed herein, fast BSS transition is supported during E911 calls or other emergency services provided in network 100. Because STAs may access E911 services without authenticating with an AP, no authentication and key derivation functions are performed, and thus delays typically associated with security and QoS functions are averted. Accordingly, a STA can roam from one AP to another AP during an E911 call by simply repeating the initial connect procedure.

In another embodiment, interoperability with fast BSS transition enabled systems may be implemented by allowing a STA to decide whether fast transition abilities are desired. In this implementation, when a STA makes an initial connection for E911 service, pre-authentication and keying models are performed by the STA prior to a transition, e.g., in accordance with the IEEE 802.11r standard. If a STA is not to perform fast transitions, the STA may assert an E9111 connection without any authentication procedures. To implement such a mechanism, a pre-shared key (PSK) mechanism may be deployed wherein a pre-shared key is provided to STAs. Such a mechanism would allow the use of fast BSS transition procedures of unauthenticated STAs in general accordance with those specified in IEEE 802.11r.

As described, embodiments disclosed herein provide a system and method for asserting emergency services in a wireless local area network. A station may assert an emergency service in a network by generating an association request that includes an indication of a request for an emergency service. The association request is transmitted to a network access point, and the station may be associated with the access point without engaging in an authentication procedure. Additionally, a network access point is provided that facilitates provisioning of emergency services to authenticated or unauthenticated network stations. An access point receives an association request that includes an indication of a request for an emergency service, and transmits an association response to a station that originated the association request. The originator of the association request may be associated with the access point without the access point engaging in an authentication procedure with the requesting station. Additionally, the access point may segregate emergency service traffic from general-purpose traffic to prohibit exploitation of the emergency service to fraudulently access other network services.

Embodiments disclosed herein may be implemented as an executable instruction set embodied in hardware, software, firmware, or a combination thereof and may comprise computer-executable instructions or code that may be fetched from a memory and executed by a processing unit of a data processing system. Computer-executable instructions that implement embodiments disclosed herein may be maintained or executed, in whole or in part, within a WLAN STA, an expansion card interfaced therewith, a WLAN AP, or a combination thereof. The instruction set is preferably maintained on any one of various computer-readable mediums. In the context of this document, a “computer-readable medium” can be any means that can contain, store, communicate, propagate or transport the instruction set for use by or in connection with an instruction execution system, apparatus, or device. The computer-readable medium can be, for example, but is not limited to, an electronic, magnetic, optical, electro-magnetic, infrared, or semi-conductor system, apparatus, device, or propagation medium now known or later developed.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of asserting an emergency service in a network, comprising:
generating an association request that includes an indication of a request for an emergency service;
transmitting the association request to a network access point; and
receiving an association response without engaging in an authentication procedure.

2. The method of claim 1, further comprising receiving an emergency service advertisement that includes an indicator of an emergency service capability.

3. The method of claim 2, wherein receiving an emergency service advertisement further comprises receiving an information element that includes the indicator implemented as a bit field.

4. The method of claim 1, further comprising receiving an emergency service advertisement in a beacon frame.

5. The method of claim 1, further comprising receiving an emergency service advertisement in a probe response frame responsive to transmitting a probe request frame.

6. The method of claim 1, further comprising receiving an emergency service advertisement in a neighbor report.

7. A method of providing an emergency service in a network, comprising:
receiving an association request that includes an indication of a request for an emergency service; and
transmitting an association response to a station that originated the association request without engaging in an authentication procedure.

8. The method of claim 7, further comprising transmitting an emergency service advertisement that includes an indicator of an emergency service capability.

9. The method of claim 8, wherein transmitting an emergency service advertisement further comprises transmitting an information element that includes the indicator implemented as a bit field.

10. The method of claim 7, further comprising transmitting an emergency service advertisement in a beacon frame.

11. The method of claim 7, further comprising transmitting an emergency service advertisement in a probe response frame responsive to receiving a probe request frame.

12. The method of claim 7, further comprising transmitting an emergency service advertisement in a neighbor report.

13. The method of claim 7, further comprising:
evaluating a station that originated the association request as currently associated; and
deleting an existing security association of the station.

14. The method of claim 7, further comprising assigning a station that originated the association request to a virtual local area network dedicated to emergency service traffic.

15. The method of claim 7, further comprising:
transmitting emergency service related traffic originated by a station that transmitted the association request over a pre-established tunnel from an access point to an emergency network; and
receiving, by the access point, emergency service related traffic originated by an entity in an emergency network over a pre-established tunnel between the access point and the emergency network.

16. A device adapted to perform communications in a network, comprising:
a memory adapted to store a set of executable instructions; and
a processing unit adapted to, responsive to execution of the set of executable instructions, generate an association request that includes an indication of a request for an emergency service, transmit the association request to a network access point, and receive an association response without engaging in an authentication procedure.

17. The device of claim 16, wherein the processing unit receives an emergency service advertisement that includes an indicator of an emergency service capability.

18. The device of claim 17, wherein the emergency service advertisement comprises an information element that includes the indicator implemented as a bit field.

19. The device of claim 17, wherein the processing unit receives the emergency service advertisement in a beacon frame.

20. The device of claim 17, wherein the processor receives the emergency service advertisement in a probe response frame responsive to transmitting a probe request frame.

21. The device of claim 16, further comprising a wireless network interface implemented as one of a secure digital input/output card, a compact flash card, a miniPCI port card, and a PCMCIA card.

22. The device of claim 16, wherein the processor receives an emergency service advertisement in a neighbor report.

23. A device adapted to provide an emergency service in a network, comprising:
a wireless interface;
a memory adapted to store a set of executable instructions; and
a processing unit adapted to receive an association request on the wireless interface,
wherein the association request includes an indication of a request for an emergency service, and, responsive to execution of the set of executable instructions, transmit an association response without engaging in an authentication procedure.

24. The device of claim 23, wherein the processing unit transmits an emergency service advertisement that includes an indicator of an emergency service capability.

25. The device of claim 24, wherein the emergency service advertisement comprises an information element that includes the indicator implemented as a bit field.

26. The device of claim 23, wherein the processing unit transmits an emergency service advertisement in a beacon frame.

27. The device of claim 26, wherein the processing unit transmits an emergency service advertisement in a probe response frame responsive to receiving a probe request frame on the wireless interface.

28. The device of claim 26, wherein the memory includes a data structure adapted to associate a station with a virtual local area network, and wherein the processing unit assigns a station that originated the association request to a virtual local area network dedicated to emergency service traffic.

29. The device of claim 23, wherein the processing unit transmits an emergency service advertisement in a neighbor report.

30. The device of claim 23, wherein the processing unit evaluates a station that originated the association request as currently associated and, responsive thereto, deletes a security association of the station.
